(19) United States
(12) Patent Application Publication
(10) Pub. No.: US 2013/0016128 A1
(43) Pub. Date: Jan. 17, 2013

(54) Tiled Zoom of Multiple Digital Image Portions

(71) Applicant: Nikhil Bhatt, Cupertino, CA (US)

(72) Inventor: Nikhil Bhatt, Cupertino, CA (US)

(73) Assignee: APPLE INC., Cupertino, CA (US)

(21) Appl. No.: 13/182,407

(22) Filed: Jul. 13, 2011

(51) Int. Cl. G09G 5/00

(52) U.S. Cl. 345/661

(57) ABSTRACT

Methods, systems, and apparatus, including computer programs encoded on computer storage media, are described for zooming on multiple digital image portions. In one aspect, methods include the actions of concurrently displaying a plurality of digital images in respective panels of a graphical user interface. The methods further include the actions of receiving user input requesting to zoom onto faces depicted in the digital images, where the faces include either human faces or animal faces. In response to receiving the user input and for each of the plurality of digital images, the methods include the actions of obtaining a set of tiles such that each of the tiles bounds a face depicted in the image. In addition, the methods include the actions of switching from concurrently displaying the plurality of digital images to concurrently displaying the generated sets of tiles in the respective panels, such that each of the sets of tiles replaces a digital image for which the set of tiles was obtained.

### BACKGROUND

This specification relates to zooming on multiple digital image portions, for example, by generating tiles associated with multiple digital image portions that have a specified feature and displaying the generated tiles at a designated zoom-level.

A user of a digital image viewer application can provide manual input requesting the image viewer to zoom into an image displayed in a viewing region. For example, the user can provide the input by placing a cursor at a desired location of the image or by touching the desired location of the image. Upon receiving this type of location specific input from the user, the viewer application can zoom into the location of the image where input was provided by the user. In this manner, if the user then wants to zoom into other desired locations either on the same image or on other images that are concurrently displayed in the viewer, the user typically provides additional inputs at the other desired locations, respectively, in a sequential manner.

As another example, the user can provide an input to zoom into multiple images displayed in the viewing region via a user interface control associated with the viewer application, e.g. a menu item, a control button, and the like. Upon receiving such input from the user, the viewer application zooms into the center of the multiple images, respectively.

### SUMMARY

Technologies described in this specification can be used, for example, to quickly compare multiple persons' faces in an image and/or instances of a same person's face across multiple images. In some implementations, a user can be presented with a tiled zoomed view of each face in an image, and thus can examine attributes of faces depicted in the images. For example, using the tiled zoomed views described in this specification, a user can determine which faces in the image are in focus or otherwise desirable. In other implementations, the described technologies can be used to compare instances of a person's face across multiple images. In this manner, while viewing multiple images side-by-side, the user can zoom into each instance of a particular person's face and, at this zoom level, the user can determine, for example, which of the multiple instances of the particular person's face are better than others, for example, one image may be in focus while one or more of the other images may be out of focus.

In general, one aspect of the subject matter described in this specification can be implemented in methods that include the actions of concurrently displaying a plurality of digital images in respective panels of a graphical user interface. The methods further include the actions of receiving user input requesting to zoom onto faces depicted in the digital images, where the faces include either human faces or animal faces. In response to receiving the user input and for each of the plurality of digital images, the methods include the actions of obtaining a set of tiles such that each of the tiles bounds a face depicted in the image. In addition, the methods include the actions of switching from concurrently displaying the plurality of digital images to concurrently displaying the obtained sets of tiles in the respective panels, such that each of the sets of tiles replaces a digital image for which the set of tiles was obtained.

The foregoing and other implementations can each optionally include one or more of the following features, alone or in combination. In some implementations, concurrently displaying the plurality of digital images in the respective panels corresponds to a first zoom-level smaller than 100%, and concurrently displaying the obtained sets of tiles in the respective panels corresponds to a second zoom-level larger than the first zoom-level and no larger than 100%. In some implementations, for each of the plurality of digital images, obtaining the set of tiles can include the actions of detecting a set of faces depicted in the digital image upon receiving the zoom request, and generating the set of tiles such that each of the tiles bounds a detected face. In other implementations, for each of the plurality of digital images, obtaining the set of tiles can include the actions of accessing and retrieving the set of tiles that was generated prior to receiving the zoom request.

In some implementations, concurrently displaying the obtained sets of tiles in the respective panels can include the actions of displaying each of the sets based on a display order within a set of tiles obtained for a particular image. For example, the particular image is an image from among the plurality of digital images that has a largest quantity of depicted faces. As another example, the particular image is an image from among the plurality of digital images that has a largest quantity of depicted faces that are members of a specified group. As yet another example, the particular image is user specified. Further, the display order within the set of tiles can be based on a detection order of the faces depicted in the particular image. Furthermore, the display order within the set of tiles can be based on identity of unique individuals associated with the faces depicted in the particular image.

In some implementations, the methods can include the actions of receiving a user selection of a tile from among the obtained set of tiles that is displayed in one of the panels, removing one or more unselected tiles from among the obtained set of tiles displayed in the panel associated with the selected tile, and displaying the selected tile in the panel at a third zoom-level larger than the second zoom-level and less than or equal to 100%, in response to removing the unselected tiles. In some implementations, the methods can include the actions of receiving selection of a tile from among the obtained set of tiles displayed in one of the panels, where the selected tile is associated with a depicted face. In addition, for each of the respective panels corresponding to the plurality of digital images, the methods can include the actions of removing one or more tiles that are not associated with instances of the depicted face with which the selected tile is associated; and displaying in the panel a tile associated with an instance of the depicted face with which the selected tile is associated, such that displaying the tile corresponds to a third zoom-level larger than the second zoom-level and less than or equal to 100%, in response to removing the tiles that are not associated with the instances of the depicted face with which the selected tile is associated.

According to another aspect, the subject matter can also be implemented in methods that include the actions of displaying a digital image in a predetermined region of a user interface and receiving a user specification of a feature associated with a portion of the digital image. Further, the methods include the actions of detecting a set of two or more image portions, such that each of the detected image portions includes the specified feature, and generating a set of tiles, such that each of the generated tiles includes a corresponding image portion from among the set of detected image portions. In addition, the methods include the actions of scaling a select quantity of the generated tiles to be concurrently displayed in the predetermined region of the user interface.

The foregoing and other implementations can each optionally include one or more of the following features, alone or in combination. In some implementations, the user specification can specify that the image portion depicts an object. For example, the object can be a human face. As another example, the object can be an animal face. As yet another example, the object can be a vehicle or a building. In some implementations, the user specification specifies that the image portion is in focus. In some implementations, the user specification specifies that the image portion can include a predetermined image location. For example, the predetermined image location can be an image location to which the user zoomed during a previous viewing of the digital image. As another example, the predetermined image location can be any one of the centers of quadrants of the digital image. In some implementations, the methods can also include the actions of receiving a user selection of the quantity of the scaled tiles to be concurrently displayed in the predetermined region of the user interface.

In some implementations, the methods can also include the actions of concurrently displaying the select quantity of scaled tiles in the predetermined region of the user interface at a zoom level that is less than or equal to 100% and larger than a zoom-level at which the digital image was displayed in the predetermined region. Concurrently displaying the select quantity of scaled tiles in the predetermined region of the user interface can be performed in accordance with a display order that is different from a detection order. The methods can include the actions of concurrently displaying at least one other digital image in respective other predetermined regions of the user interface. Also, for each of the other digital images, the methods can include the actions of generating a set of tiles such that each tile includes an image portion detected to include the specified feature, and scaling each of the set of tiles to be concurrently displayed in the other predetermined region associated with the other digital image. Additionally, the methods can include the actions of concurrently displaying at least one set of scaled tiles corresponding to the other digital images in the associated other predetermined regions at a respective zoom level that is less than or equal to 100% and larger than respective zoom-levels at which the other digital images were displayed in the associated other predetermined region. Concurrently displaying the sets of scaled tiles in the associated other predetermined regions of the user interface can be performed in accordance with the same display order used for concurrently displaying the select quantity of scaled tiles in the predetermined region of the user interface.

In some implementations, the methods can include the actions of receiving user selection of a tile from among the select quantity of scaled tiles displayed in the predetermined region of the user interface. The selected tile can include an image portion including the specified feature, such that the specified feature has a specified attribute. In addition, for each of the predetermined region and the other predetermined regions corresponding to the digital image and to the other digital images, respectively, the methods include the actions of removing one or more tiles that include image portions for which the specified feature does not have the specified attribute, and displaying in the associated predetermined region a tile that includes an image portion for which the specified feature has the specified attribute. For example, the specified feature specifies that the image portion depicts a human face or an animal face and the specified attribute specifies that the depicted face is associated with a specified person or a specified pet.

According to another aspect, the subject matter can also be implemented in a system that includes one or more computers and one or more storage devices storing instructions that are operable, when executed by the one or more computers, to cause the system to perform operations including displaying two or more digital images in respective panels at respective initial zoom-levels. In response to receiving user input requesting to zoom onto human or animal faces depicted in the digital images, the operations can include displaying two or more sets of depicted faces in the respective panels corresponding to the two or more digital images. The sets of depicted faces can be displayed at respective zoom-levels larger than the initial zoom-levels at which the corresponding digital images were displayed.

The foregoing and other implementations can each optionally include one or more of the following features, alone or in combination. In some implementations, the operations further include detecting the respective sets of faces in the two or more displayed digital images upon receiving the user request. In other implementations, the operations further include accessing and retrieving the respective sets of faces in the two or more displayed digital images that were detected prior to receiving the user request. In some implementations, the operations further include receiving selection of a face from among the set of depicted faces displayed in a panel from among the respective panels corresponding to the two or more digital images, and removing unselected faces from among the set of depicted faces displayed in the panel. In some implementations, the operations further include receiving selection of a face from among the set of depicted faces displayed in a panel from among the respective panels corresponding to the two or more digital images, and removing instances of unselected faces from among the respective sets of depicted faces displayed in the respective panels corresponding to the two or more digital images.

In some implementations, displaying the respective sets of the depicted faces can include sorting the respective sets by relative positions within the corresponding two or more digital images. In some implementations, displaying the respective sets of the depicted faces comprises sorting the respective sets by an identity of the depicted faces.

Particular implementations of the subject matter described in this specification can be configured so as to realize one or more of the following potential advantages. The described techniques enable a user to compare multiple faces detected in an image among each other, e.g., to determine a quality/characteristic that is common to each of the multiple detected faces. In this manner, the user can examine each of the faces detected in the image on an individual basis. Additionally, the user can compare multiple instances of a same person's face that were detected over respective multiple images, e.g., to determine an attribute that is common to each of the multiple detected instances of the person's face across the multiple images.

Moreover, the described technologies can be used to concurrently display two or more portions of an image that are in focus to allow a user to quickly assess whether or not content of interest is depicted in the displayed image portions. In addition, the systems and processes described in this specification can be used to concurrently display, at high zoom-level, predetermined image portions from a plurality of images. An example of such predetermined portion is (a central area of) an image quadrant. This enables a user to determine a content feature that appears in one or more of the four quadrants of an image, or whether the content feature appears in one or more instances of a quadrant of multiple images, for instance. The disclosed techniques can also be used to quickly examine, at high zoom-level and within an image or across multiple images, image portions to which the user has zoomed during previous viewings of the image(s).

Details of one or more implementations of the subject matter of this specification are set forth in the accompanying drawings and the description below. Other features, aspects, and potential advantages of the subject matter will become apparent from the description, the drawings, and the claims.

### BRIEF DESCRIPTION OF THE DRAWINGS

FIG. 1 illustrates an example of a system that provides tiled zoom of multiple image portions that have a specified feature.

FIGS. 2A-2C show aspects of a system that provides tiled zoom of image portions corresponding to faces detected in an image.

FIGS. 3A-3D show aspects of a system that provides tiled zoom of image portions corresponding to faces detected in multiple images.

FIG. 4 shows an example of a method for providing tiled zoom of multiple image portions that have a specified feature.

FIG. 5 is a block diagram of an example of a mobile device operated according to the technologies described above in connection with FIGS. 1-4.

FIG. 6 is a block diagram of an example of a network operating environment for mobile devices operated according to the technologies described above in connection with FIGS. 1-4.

Like reference numbers and designations in the various drawings indicate like elements.

### DETAILED DESCRIPTION

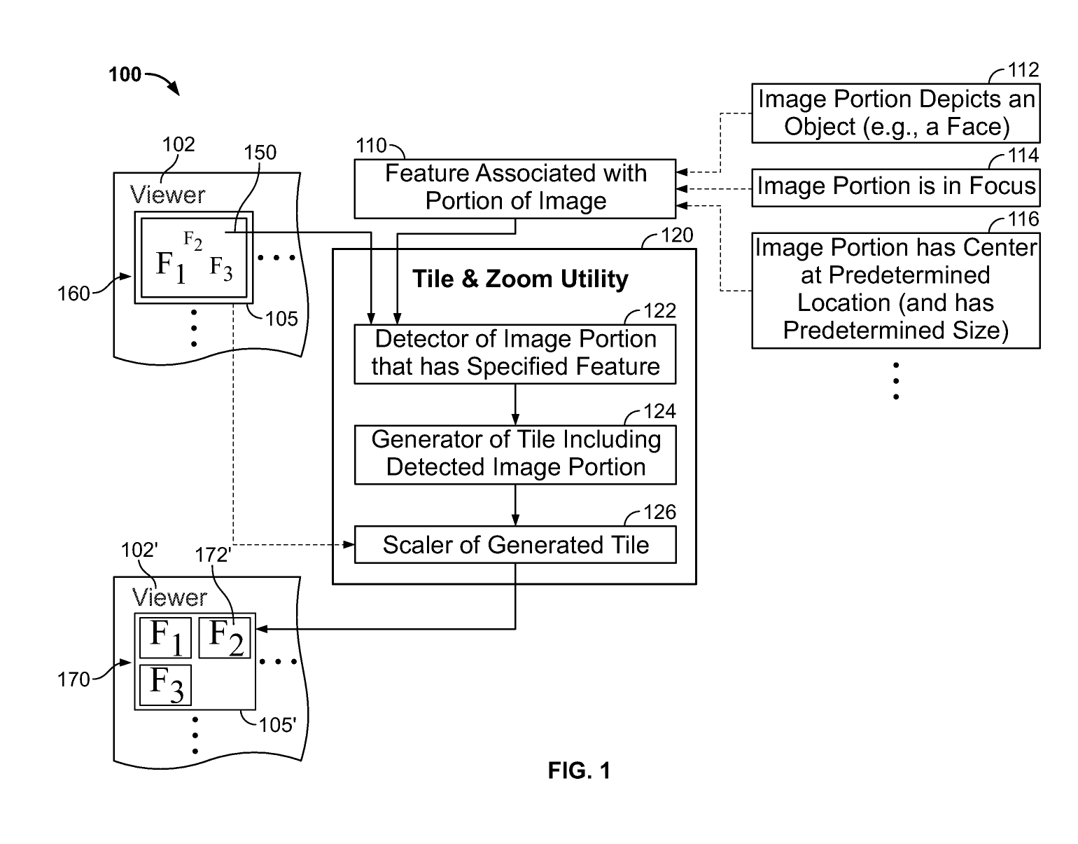

FIG. 1 illustrates a system 100 that provides tiled zoomed views of multiple image portions that have a specified feature. The system 100 can be implemented as part of an image processing application executed by a computer system. The system 100 can include a user interface that provides controls and indicators that a user associated with the image processing application can use to view images, select which image of the viewed images should be presented and specify how to present the selected image. The system 100 can also include a plurality of utilities that carry out under-the-hood processing to generate the specified views of the selected image(s).

The user interface of the system 100 can include a viewer 102 that displays at least one image 150. The image 150 can be displayed in a predetermined region of the viewer 102, for example in a panel 105. A view of the image 150 as displayed in the panel 105 corresponds to a zoom-level determined by the relative size of the image 150 with respect to the panel 105. For example, if the size of panel 105 is (⅖)^{th} of the size of the image 150, then the zoom-level corresponding to viewing the entire image 150 in the panel 105 is 40%. Other images can be displayed in the viewer 102 in respective other panels, as indicated by the ellipses in the horizontal and vertical directions.

The plurality of utilities of the system 100 can include a tile and zoom utility 120. The tile and zoom utility 120 can receive as input the image 150 selected by the user and a specification 110 of a feature F associated with a portion of the image 150. In the image 150, first, second and third image portions 160, each of which having the specified feature F, are denoted by F1, F2 and F3, respectively. In some implementations, the feature F can be specified by the user of the image processing application, by selecting the feature F from among a set of available features, as described below. In other implementations, the feature F can be specified programmatically. Moreover, the tile and zoom utility 120 can generate a tiled zoomed view of the image portions 160 of the received image 150 which have the user specified feature 110.

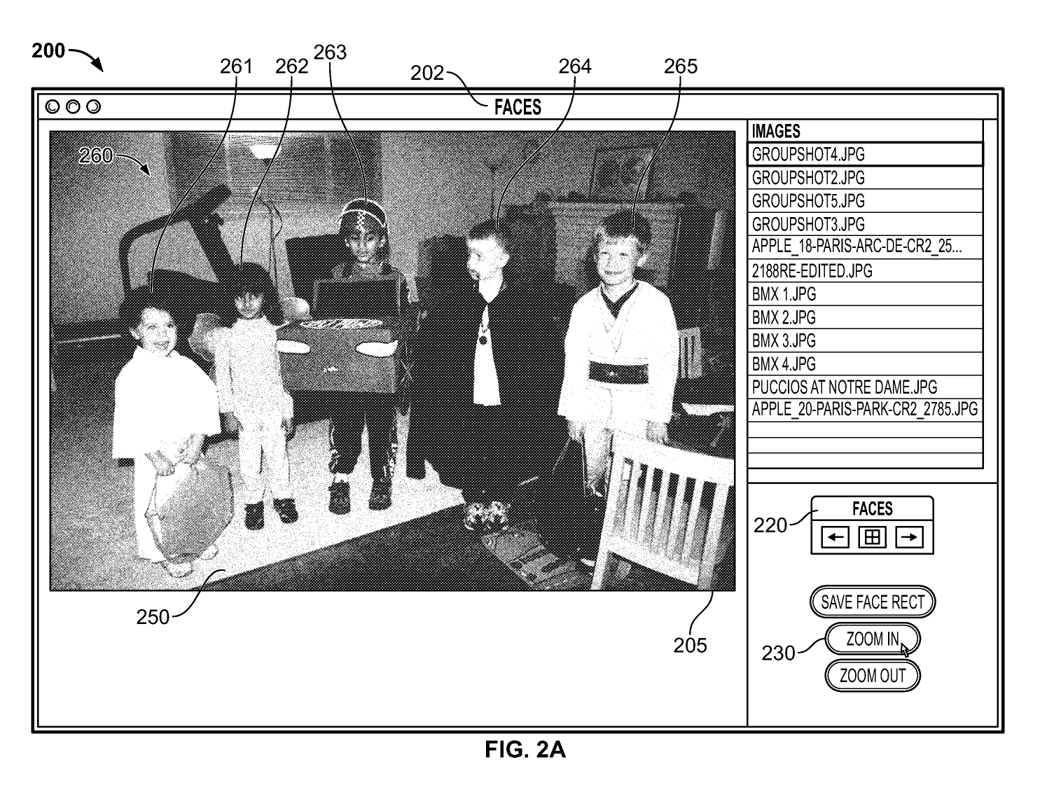

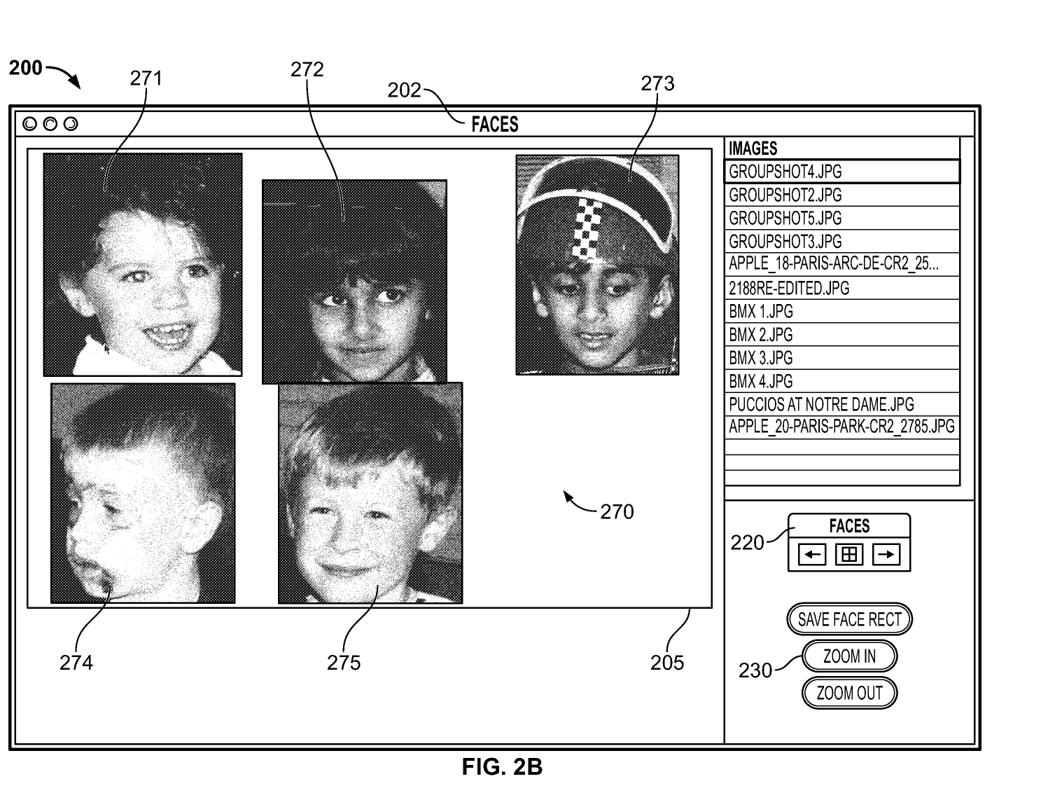

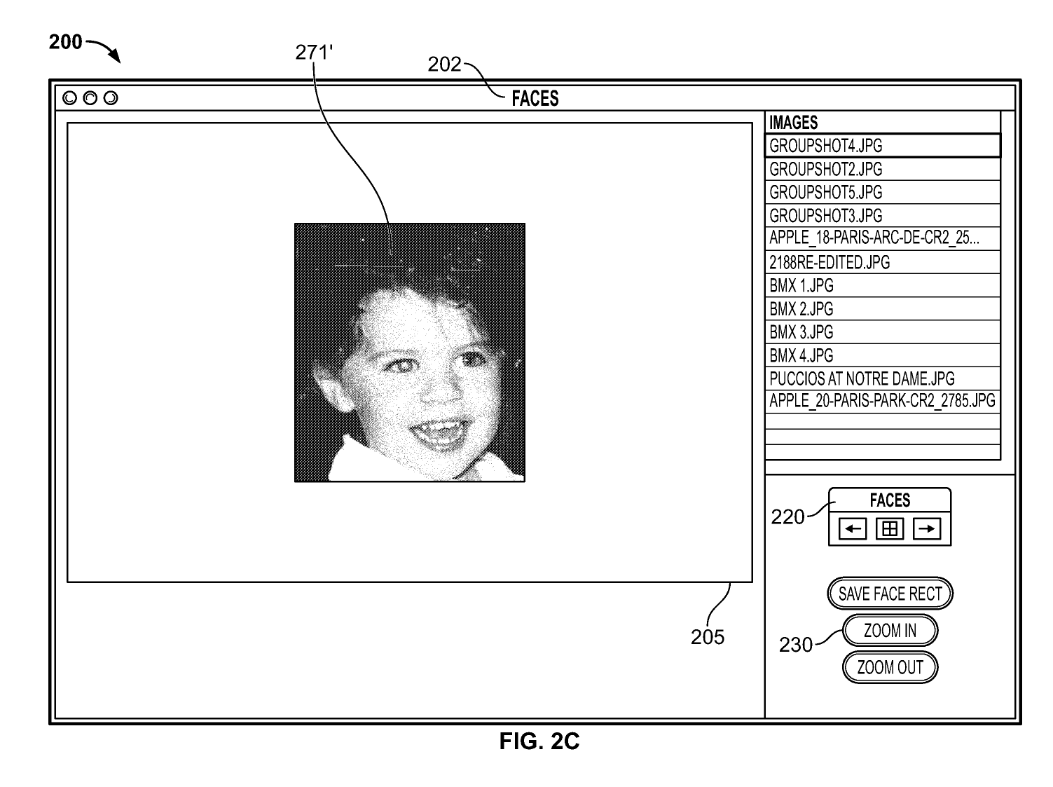

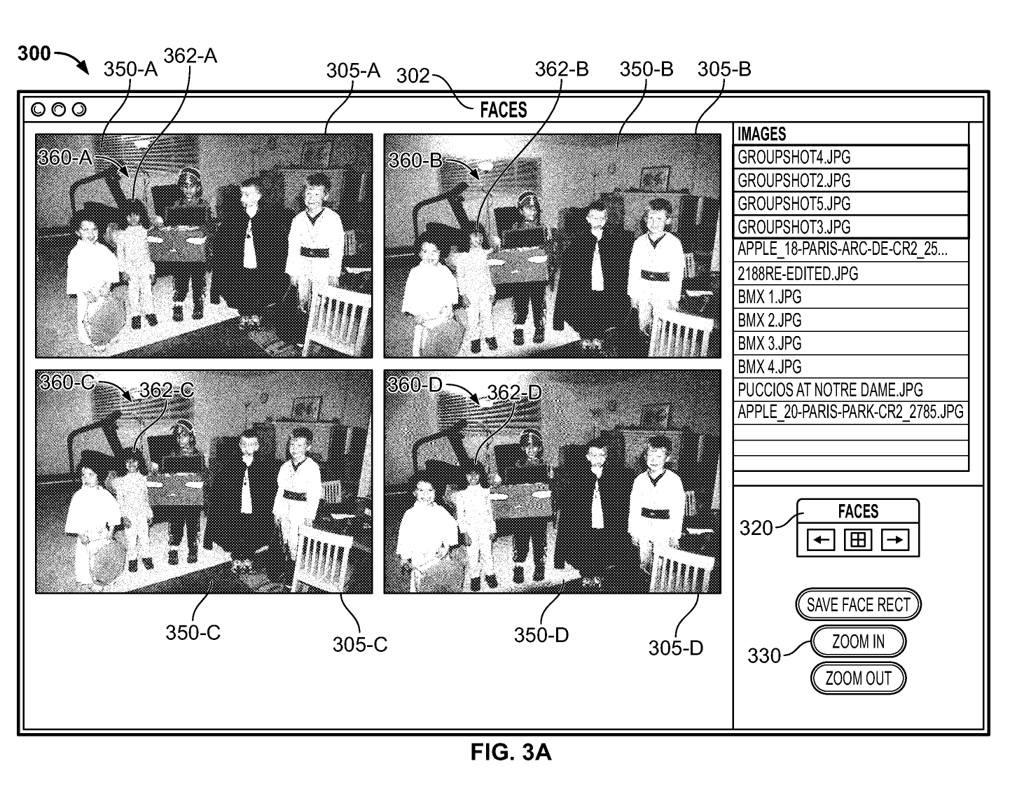

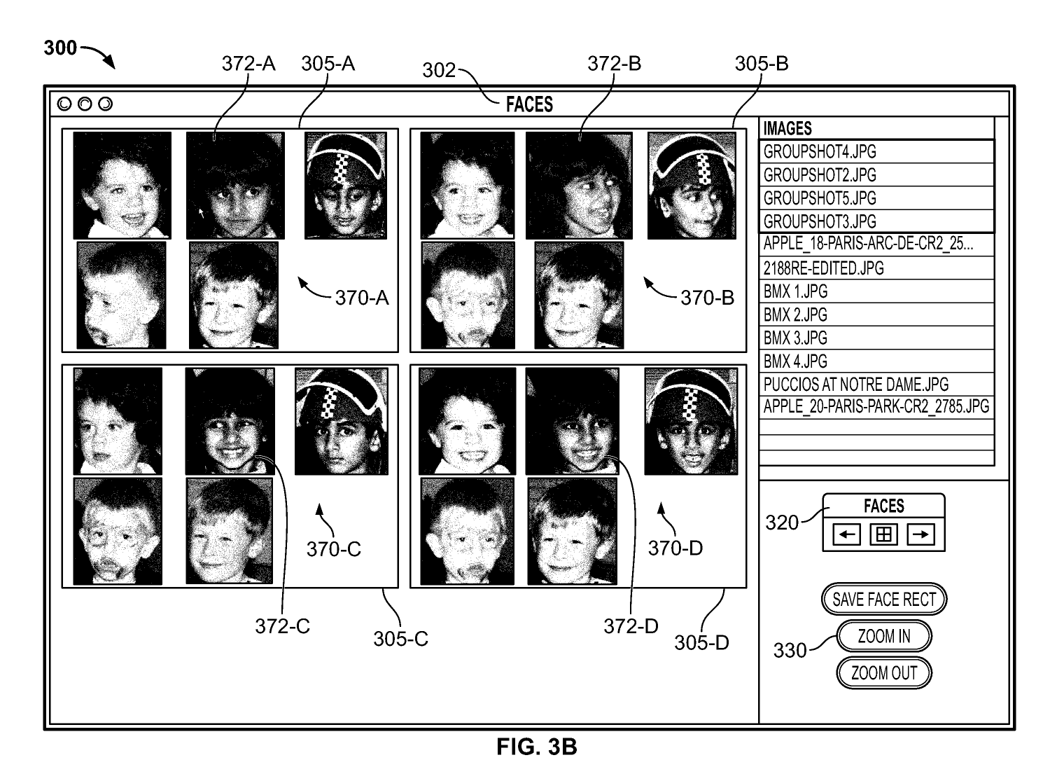

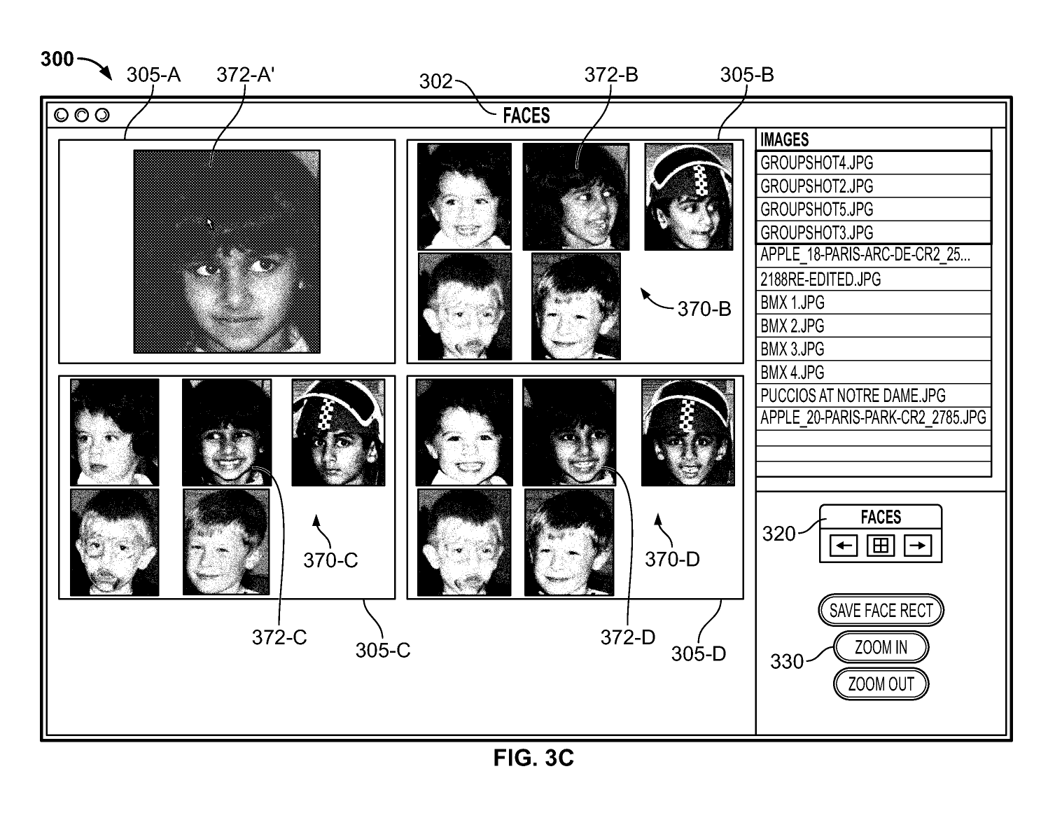

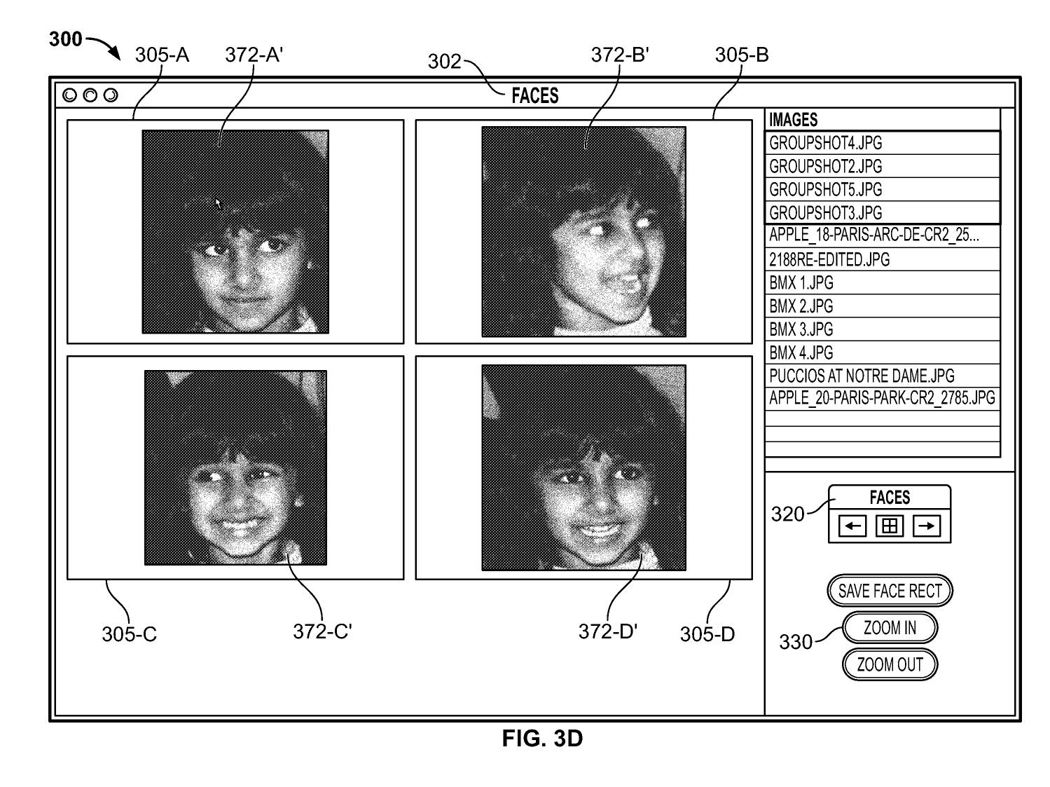

In some implementations, the specified feature 112 of an image portion is that the image portion depicts an object. For example, the object depicted in the image portion can be a human face, an animal face, or in short, a face. Implementations of the tile and zoom utility 120 described below in connection with FIGS. 2A-2C and 3A-3D correspond to cases for which the user specifies that if a portion of an image depicts a face, then the tile and zoom utility 120 zooms into the image portion. As another example, the depicted object can be a vehicle, a building, etc.

In other implementations, the specified feature 114 of an image portion is that the image portion is in focus. For example, the user can specify that if a portion of an image includes a focus location, then the tile and zoom utility 120 zooms into the image portion. In some other implementations, the specified feature 116 of an image portion is that the image portion includes a predetermined image location/pixel. For example, a predetermined location/pixel of an image can be the location/pixel to which the user selected to zoom during a most recent view of the image. As another example, predetermined locations can be respective centers of the 1^{st}, 2^{nd}, 3^{rd} and 4^{th} quadrants of the image. In yet some other implementations, the user can specify another feature that an image portion must have for the tile and zoom utility 120 to zoom into the image portion.

In general, a tiled zoomed view of the received image 150 is prepared based on the specified feature 110, by various modules of the tile and zoom utility 120, to output a set of tiles 170, each output tile including a portion of the image 150 that has the specified feature 110. In FIG. 1, these various modules include a detector 122 of an image portion that has the specified feature, a generator 124 of a tile including the detected image portion, and a scaler 126 to scale/zoom the generated tile. The output set of tiles 170 can be displayed in the panel 105′ of the viewer 102′ (the latter representing subsequent instances of the panel 150 and of the viewer 102, respectively.) Views of the image portions F1, F2 and F3 included in the output set of tiles 170 as displayed in the panel 105′ correspond to respective zoom-levels that each is relatively larger than the zoom-level of the view of the image 150 in the panel 105. In some implementations, however, each of the zoom-levels corresponding to the image portions F1, F2 and F3 included in the output set of tiles 170 as displayed in the panel 105′ is less than 100%.

The tile and zoom utility 120 accesses the image 150 and receives the specification 110 of the feature F from the user. The detector 122 detects the portions 160, F1, F2 and F3, of image 150, each of which having the specified feature F. In the implementations for which the specified feature 112 is that a portion of the image 150 depicts a face, the detector 122 represents a face detector. One or more face detectors can be used from among face detectors that are known in the art. The one or more face detectors can detect a first face in the image portion denoted F1, a second face in the image portion denoted F2, a third face in the image portion denoted F3, and so on. In some implementations, the image portion associated with a detected face can be defined as a rectangle that substantially circumscribes the face. In other implementations, the image portion associated with a detected face can be defined to be an oval that substantially circumscribes the face. Note that as the faces detected in the image 150 can have different sizes (e.g., the first face is the largest and the second face is the smallest of the detected faces in the image 150) the image portions F1, F2 and F3 corresponding to the respective detected faces also can have different sizes.

In the implementations for which the specified feature 114 is that a portion of the image 150 is in focus, the detector 122 can access metadata associated with the image 150, for example, to retrieve first, second and third focus locations associated with the image 150. Once the focus locations are retrieved in this manner, the detector 122 can define respective portions F1, F2 and F3 of the image 150, such that each of the detected in-focus image portions is centered on a retrieved focus location and has a predetermined size. In another example, the detector 122 is configured to detect a set 160 of portions F1, F2, F3 of the image 150 that are in focus by actually analyzing the content of the image 150 with at least one or more from among focused-content detectors that are known in the art.

In the implementations for which the specified feature 116 is that a portion of the image 150 is centered at a predetermined location, the detector 122 can access metadata associated with the image 150 to retrieve first, second and third predetermined locations associated with the image 150, for example, to which the user selected to zoom during a most recent view of the image 150. As another example, the predetermined locations can be respective centers of the 1^{st}, 2^{nd}, 3^{rd} and 4^{th} quadrants of the image. Once the predetermined locations are retrieved in this manner, the detector 122 can define respective portions F1, F2 and F3 of the image 150, such that each of the detected image portions is centered on a retrieved predetermined location and has a predetermined size.

The set 160 of detected image portions F1, F2, F3 that have the specified feature F are input to the tile generator 124. The tile generator 124 generates a tile for each of the detected image portions that have the specified feature, such that the generated tile includes the content of the detected image portion. For example, a tile 172 is generated by cropping from the image 150 the corresponding image portion F2 detected by the detector 122 to have the specified feature F. As another example, a tile 172 is generated by filling a geometrical shape of the image portion F2 with image content corresponding to the image portion F2 detected by the detector 122 to have the specified feature F.

In this manner, the generated tiles including the respective image portions that were detected to have the specified feature can have different sizes. Note that as the detected image portions F1, F2 and F3 in the image 150 can have different sizes, the tiles corresponding to the image portions F1, F2 and F3 generated by the tile generator 124 also can have different sizes. For example in FIG. 1, the tile corresponding to the image portion F2 generated by the tile generator 124 is the smallest tile in the set of generated tiles because it corresponding to the smallest image portion F2 detected to have the specified feature.

The scaler 126 receives from the tile generator 124 the tiles generated to include the respective image portions that were detected to have the specified feature 110. In some instances, however, in the implementations for which the specified feature 112 is that a portion of the image 150 depicts a face, the face detector 122 and the tile generator 124 can be applied by the system 100 prior to displaying the image 150 in the panel 105 of the viewer 102. In such instances, the tile and zoom utility 120 can access and retrieve the previously generated tiles without having to generate them on the fly. The scaler 126 can scale the generated tiles based on a quantity of tiles from among the scaled tiles 170 to be concurrently displayed in a region 105′ of the viewer 102′. In some implementations, the scaler 126 can scale the tiles generated by the tile generator 124 to maximize a cumulative size of the quantity of tiles displayed concurrently within the panel 105′. In some implementations, the output tiles 170 are scaled by the scaler 126 to have substantially equal sizes among each other. In some other implementations, the scaler 126 can scale the generated tiles such that when concurrently displayed, none of the views corresponding to the scaled tiles 170 exceeds a zoom-level of 100%. In FIG. 1, the scaler 126 scales the generated tiles corresponding to detected image portions F1, F2 and F3, such that the scaled tiles 170 are substantially equal in size to each other when concurrently displayed in panel 105′.

A user of the image processing application associated with the system 100 can examine the output set of tiles 170 displayed in the panel 105′ of the viewer 102′. By viewing the portions 160 of the image 150 as equal sized-tiles 170 displayed side-by-side in the panel 205′ of the viewer 102′, the user can assess quality of content associated with the specified feature more accurately and faster relative to performing this assessment when the image 150 is displayed in the panel 105 of viewer 102. Such content quality assessment can be accurate because the tile and zoom utility 120 detects and zooms into the portions of the image 150 having the specified feature. Alternatively, to perform the content quality assessment the user would have to manually select and zoom into portions of the image 150 that have the specified feature. In addition, the foregoing assessment process is faster because the tile and zoom utility 120 automatically detects and zooms into all the portions of the image 150 having the specified feature, while the user would have to manually and sequentially select and zoom into one-portion at-a-time from among the portions of the image 150 that have the specified feature. Example implementations of the tile and zoom utility 120 are described below.

FIGS. 2A-2C show aspects of a system 200 that provides tiled zoom of image portions corresponding to faces depicted in an image 250. The system 200 can be implemented, for example, as an image processing application. Further, the system 200 can correspond to the system 100 described above in connection with FIG. 1 when the specified feature of an image portion is that the image portion depicts a face.

The system 200 can include a graphical user interface (GUI) 202. The GUI 202 can present to a user associated with the system 200 a panel 205 used to display the image 250. In some implementations, the GUI 202 can include a control 230 to enable the user to zoom to the center of the image. In some implementations, the GUI 202 enables the user to enter a desired location of the image 250 displayed in the panel 205 to prompt the system 200, by using a cursor or a touch gesture, to zoom into a portion of the image 250 centered on the point of the image 250 entered by the user.

It would be desirable to present a zoomed view of faces depicted in the image 250 to allow a user associated with the system 200 to determine which of the multiple faces are in focus or otherwise desirable. To this effect, the GUI 202 can also include a control 220 through which the user can request that the system 200 zooms to portions of the image 250 depicting a face.

In response to receiving the user request, the system 200 detects the multiple faces depicted in the image 250 and extracts from the image 250 respective image portions 260 corresponding to the multiple detected faces. For example, the control 220 prompts the system 200 to generate one or more tiles including respective one or more portions 260 of the image 250, each of which depicting a face, and then to replace the image 250 in the panel 205 with the generated one or more tiles. In some instances, however, in response to receiving the user request, the system 200 obtains the one or more tiles including respective one or more portions 260 of the image 250, each of which depicting a face, that were generated prior to displaying the image 250 in the panel 205. In such instances, the system 200 can access and retrieve the previously generated tiles without having to generate them on the fly.

In the example illustrated in FIG. 2A, a first face is depicted in an image portion 261, a second face is depicted in an image portion 262, a third face is depicted in an image portion 263, a fourth face is depicted in an image portion 264, and a fifth face is depicted in an image portion 265. The system 200 can generate a set of tiles 270, each of which including an image portion that depicts a face. In some implementations, the system 200 generates the tiles automatically, for example as boxes that circumscribe the respective detected faces. In other implementations, a contour of the tile (e.g., a rectangle) that circumscribes the detected face can be drawn by the user associated with the system 200.

In the example illustrated in FIG. 2B, a first generated tile 271 includes the image portion 261 depicting the first face. Similarly, a second generated tile 272 includes the image portion 262 depicting the second face, a third generated tile 273 includes the image portion 263 depicting the third face, a fourth generated tile 274 includes the image portion 264 depicting the fourth face, and a fifth generated tile 275 includes the image portion 265 depicting the fifth face. The generated tiles 270 can be displayed based on a display index/order, e.g., left-to-right, top-to-bottom, as shown in FIG. 2B.

In some implementations, the display index can correspond to a face detection index. For example, the tile 271 that includes the image portion 261 depicting the first detected face can have a display index of 1,1 (corresponding to the first row and first column in an array of tile 270.) The tile 272 that includes the image portion 262 depicting the second detected face can have a display index of 1,2 (corresponding to the first row and second column in an array of tile 270.) And so on. In other implementations, the display index of a tile from the set of generated tiles 270 need not be the same as the detection index (order) of the face to which the generated tile is associated. For instance, the system 200 can identify persons associated with the detected faces. Therefore, the display index of the generated tiles 270 can be based on various attributes associated with the identified persons, e.g., persons' names, popularities (in terms of number of appearances in a current project/event, library, etc.), family members displayed first followed by others, and the like.

The generated tiles 270 can be sized such that a quantity of tiles from among the generated tiles 270 cumulatively occupies a largest area of the panel 205 that originally displayed the image 250. Accordingly, if a subset of the generated tiles 270 is displayed in the panel 205, each tile of the displayed subset of the generated tiles 270 has a relative size that is larger than or equal to its size when all the generated tiles 270 are being displayed in the panel 205. In some implementations, a size of a generated tile that is associated with a face may be limited to correspond to a zoom-level of the face that is less than or equal to 100%.

A user can select a tile 271 from among the set of generated tiles 270 to be displayed individually in the panel 205. FIG. 2C shows that upon receiving the user selection, the system 200 can replace the displayed tiles 270 from the panel 205 with an individually displayed tile 271′. In some implementations, the individually displayed tile 271′ can be scaled (zoomed) to fill at least one dimension of the panel 205. In other implementations, however, the individually displayed tile 271′ can be scaled up to a size which corresponds to a zoom-level of 100%.

As shown in FIG. 2B, the system 200 can be used by a user to compare the detected multiple faces among each other, e.g., to determine a quality that is common to each of the multiple detected faces. Further, the system 200 can receive input from the user to toggle between the zoomed view corresponding to FIG. 2B and the zoomed view corresponding to FIG. 2C. In addition, the control 220 includes arrows that can be used by the user to sequentially replace an individually displayed tile 271′ in the panel 205 with the succeeding or preceding individually displayed tile 272′ or 275′, respectively. Using the zoomed view corresponding to FIG. 2C, the user can assess a quality of each of the detected faces on an individual basis.

FIGS. 3A-3D show aspects of a system 300 that provides tiled zoom of image portions corresponding to faces depicted in multiple images 350-A, 350-B, 350-C and 350-D. The system 300 can be implemented, for example, as an image processing application. As another example, the system 300 can correspond to the system 100 described above in connection with FIG. 1 when the specified feature of an image portion is that the image portion depicts a face. As yet another example, the system 300 can be an extension of system 200 described above in connection with FIGS. 2A-2C or a combination of multiple instances of the system 200.

The system 300 can include a graphical user interface (GUI) 302. The GUI 302 can present to a user associated with the system 300 multiple panels 305-A, 305-B, 305-C and 305-D used to concurrently display the images 350-A, 350-B, 350-C and 350-D, respectively. Each of these images depicts an associate set of faces. At least some of the faces depicted in one of the images 305-A, 305-B, 305-C and 305-D may be depicted in other of these images. In some cases, the images 350-A, 350-B, 350-C and 350-D have been captured sequentially.

The GUI 302 can include a control 330 to enable the user to concurrently zoom to the centers of the respective images 350-A, 350-B, 350-C and 350-D. In some implementations, the GUI 302 can receive from the user (who uses a cursor or a touch gesture onto) a desired location in one of the images 350-A, 350-B, 350-C and 350-D displayed in the respective panels 305-A, 305-B, 305-C and 305-D. In response to receiving the desired location from the user, the system 300 can zoom into a portion of the image centered on the location of the image received from the user.

Once again, it would be desirable to present a zoomed view of faces depicted in the images 350-A, 350-B, 350-C and 350-D to allow the user to determine which of the multiple faces are in focus or otherwise desirable and the image(s) from among the images 350-A, 350-B, 350-C and 350-D corresponding to the determined faces. To this effect, the GUI 302 can also include a control 320 through which the user can request that the system 300 zooms to portions of the multiple images 350-A, 350-B, 350-C and 350-D depicting a face.

In response to receiving the request, the system 300 detects the associated set of faces depicted in each of the images 350-A, 350-B, 350-C and 350-D and extracts from the images 350-A, 350-B, 350-C and 350-D respective image portions 360-A, 360-B, 360-C and 360-D corresponding to the detected faces. The control 320 can prompt the system 300 to generate, for each of the images 350-A, 350-B, 350-C and 350-D, a set of one or more tiles including respective one or more image portions of the image, each of the one or more image portions depicting a face. In some instances, however, in response to receiving the user request, the system 300 obtains, for each of the images 350-A, 350-B, 350-C and 350-D, the set of one or more tiles including respective one or more image portions of the image, each of the one or more image portions depicting a face, that were generated prior to concurrently displaying the images 350-A, 350-B, 350-C and 350-D in the respective panels 305-A, 305-B, 305-C and 305-D. In such instances, the system 300 can access and retrieve the previously generated sets of tiles without having to generate them on the fly.

FIG. 3B shows that the system 300 can replace the images 350-A, 350-B, 350-C and 350-D in the respective panels 305-A, 305-B, 305-C and 305-D with the generated tile sets 370-A, 370-B, 370-C and 370-D, respectively. Using the zoomed view illustrated in FIG. 3B, the user can compare the detected multiple faces among each other, e.g., to determine a quality that is common to each of the multiple detected faces within an image of the images 350-A, 350-B, 350-C and 350-D or across the images 350-A, 350-B, 350-C and 350-D.

The system 300 is configured to maintain the same display order of faces within each of the generated tile sets 370-A, 370-B, 370-C and 370-D when displayed across panels 305-A, 305-B, 305-C and 305-D, respectively. The system 300 can identify faces depicted in each of the images 350-A, 350-B, 350-C and 350-D. Accordingly, instances of a same person's face can be selected regardless of respective positions of the person in the images 350-A, 350-B, 350-C and 350-D. For example, the system 300 detects in the image 350-A a set of image portions 360-A, each of which depicting a face. For instance, an image portion 362-A from among the set of image portions 360-A depicts a first instance of a face associated with a particular person. Further, the system 300 detects in the image 350-B a set of image portions 360-B, each of which depicting a face. An image portion 362-B depicts a second instance of the face associated with the particular person. Furthermore, the system 300 detects in the image 350-C a set of image portions 360-C, each of which depicting a face. An image portion 362-C depicts a third instance of the face associated with the particular person. Additionally, the system 300 detects in the image 350-D a set of image portions 360-D, each of which depicting a face. An image portion 362-D depicts a fourth instance of the face associated with the particular person.

In this manner, the system 300 can display the image portions 362-A, 362-B, 362-C and 362-D corresponding to the detected instances of the particular person's face in the same order in the generated tile sets 370-A, 370-B, 370-C and 370-D, respectively. The foregoing can be accomplished by using a display index corresponding to a panel that is associated with an anchor image in all other of the panels. For example, the anchor image may be displayed in the first panel 305-A. As such, the system 300 replaces the anchor image 350-A from the panel 305-A with the tile set 370-A generated to include the one or more image portions 360-A, each of which depicting a face detected in the anchor image 350-A. Determining an order of displaying the generated set of tiles 370-A associated with an anchor image 350-A in the panel 305-A, or equivalently determining the display index corresponding to the panel 305-A associated with the anchor image 350-A can be performed as described above in connection with FIG. 2B. Additionally, the tile sets 370-B, 370-C and 370-D associated with the other images 350-B, 350-C and 350-D are displayed in panels 305-B, 305-C and 305-D, respectively, based on the order (or display index) in which the tile set 370-A associated with the anchor image 350-A is displayed in panel 305-A.

In general, the system 300 can select the anchor image from among the displayed images 350-A, 350-B, 350-C and 350-D based at least on one of the criteria enumerated below. In some implementations, the anchor image represents an image from among the displayed images 350-A, 350-B, 350-C and 350-D that has the largest quantity of detected faces. In other implementations, the anchor image has the largest quantity of detected faces from a specified group, e.g. a family, a scout-den, classroom, and the like. In some other implementations, the anchor image has the largest quantity of popular faces. The latter represent faces that appear in an image library, project, event, and the like, with frequencies that exceed a threshold frequency.

In case a person is missing from a particular image from among the images 350-B, 350-C and 350-D different from the anchor image 350-A, e.g., a person identified in the anchor image 350-A is not identified among the detected faces associated with the particular image, the system 300 can handle this situation in multiple ways. In some implementations, a set of tiles generated in association with the particular image has at least one tile less than the tile set 370-A associated with the anchor image 350-A. Accordingly, a smaller (sparser) tile set is displayed in the panel associated with the particular image compared to the tile set 370-A displayed in the panel 305-A associated with the anchor image 350-A. In other implementations, a tile corresponding to a missing face can be generated as a substitution tile to maintain a size of the tile set associated with the particular image the same as the size of the tile set 370-A associated with the anchor image 350-A. For example, the substitution tile can include a face icon, or another face representation. Alternatively, the substitution tile may include a text label, e.g., a name of the missing person, a symbol, e.g., “?”, “!”, and the like. As another example, the substitution tile can be an empty tile. The empty substitution tile may have a solid background (filling) that is colored in the same or a different color as the background of the panel in which the empty substitution tile is displayed. Alternatively, the empty substitution tile may have no background (clear filling) and may or may not have a contour line.

In case there is an extra person in a particular image from among the images 350-B, 350-C and 350-D different from the anchor image 350-A, e.g., a person identified among the detected faces associated with the particular image is not identified in the anchor image 350-A, the system 300 can handle this situation in multiple ways. In some implementations, a tile corresponding to the extra face can be added as the last tile of the tile set associated with the particular image. In other implementations, a tile corresponding to the extra face can be inserted in the tile set associated with the particular image based on a rule that was used to determine the display index of the tile set 370-A associated with the anchor image 350-A. For example, if the tile set 370-A associated with the anchor image 350-A is displayed in alphabetical order by first name, then the tile corresponding to the extra face is inserted into the tile set associated with the particular image to obey this display order.

A face can be selected in any of the tile sets 370-A, 370-B, 370-C and 370-D shown in the zoomed view corresponding to FIG. 3B. In response to receiving the face selection, the system 300 can display only the tile associated with the selected face and can leave unchanged the way the other tile sets are displayed, as shown in FIG. 3C. The faces matching the selected face can be displayed by the system 300 as the only face in each tile set in the zoomed view corresponding to FIG. 3D.

The user can select a tile, e.g. 372-A, from among a set of tiles 370-A to be displayed individually in the panel 305-A associated with the image 350-A from which the set of tiles 370-A was generated. As described above in connection with FIG. 3A, the tile 372-A corresponds to a region 362-A of the image 350-A depicting the first instance of the particular person' face. FIG. 3C shows that upon receiving the user selection, the system 300 can replace the displayed tile set 370-A from the panel 305-A with an individually displayed tile 372-A′. The individually displayed tile 372-A′ can be scaled (zoomed) to fill at least one dimension of the panel 305-A, for example. In some implementations, however, the individually displayed tile 372-A′ can be scaled up to a size which corresponds to a zoom-level that does not exceed 100%. In addition, arrows of the control 320 can be used by the user to sequentially replace an individually displayed tile 372-A′ in the panel 305-A with the succeeding or preceding individually displayed tile from the set of tiles 370-A. In addition, each of the panels 305-B, 305-C and 305-D that is different from the image panel 305-A displaying the selected face continues to display the set of detected faces in the image associated with the panel. Accordingly, the panel 305-B displays the tile set 370-B, the panel 305-C displays the tile set 370-C, and the panel 305-D displays the tile set 370-D.

Moreover, the user can select tiles 372-A, 372-B, 372-C and 372-D corresponding to image portions 362-A, 362-B, 362-C and 362-D depicting respective instances of the particular person' face. In some implementations, the user selection includes individual selections of the tiles 372-A, 372-B, 372-C and 372-D. For example, selections of multiple tiles can be entered by the user in a sequential manner, using a cursor or a touch-gesture. As another example, the selections of the multiple tiles can be entered concurrently using a multi-touch gesture. In other implementations, the user selection includes a selection of one tile, e.g. 372-A. Then, the system 300 automatically selects, from among the other tile sets 370-B, 370-C, 370-D based on the selected person's identity, the tiles 372-B, 372-C, 372-D corresponding to the other instances of the particular person's face.

FIG. 3D shows that upon receiving one or more of the foregoing user selections, the system 300 can replace the displayed tile sets 370-A, 370-B, 370-C, 370-D from the panels 305-A, 305-B, 305-C, 305-D, respectively, with individually displayed tiles 372-A′, 372-B′, 372-C′, 372-D′. In some implementations, the individually displayed tiles 372-A′, 372-B′, 372-C′, 372-D′ can be scaled (zoomed) to fill at least one dimension of the panels 305-A, 305-B, 305-C, 305-D, respectively. In some implementations, however, the individually displayed tiles 372-A′, 372-B′, 372-C′, 372-D′ can be scaled up to respective sizes which correspond to a zoom-level that does not exceed 100%. Using the zoomed view illustrated in FIG. 3D, the user can assess a quality of the respective instances of the selected face at a zoom-level larger than the zoom-levels corresponding to the zoom-views illustrated in FIGS. 3B and 3C. Further, the system 300 can receive input from the user to toggle between the zoomed views illustrated in FIGS. 3B and 3D. Furthermore, the system 300 can receive input from the user to toggle between the zoomed views illustrated in FIGS. 3C and 3D.

In addition, arrows of the control 320 can be used by the user to switch between concurrently displaying multiple instances of a person's face to concurrently displaying multiple instances of another person's face. In the example shown in FIGS. 3A-3D, the tiles 372-A, 372-B, 372-C, 372-D corresponding to the particular person's face have a display index of 2 (i.e., these tiles occupy position 2 when displayed as part of tile sets 370-A, 370-B, 370-C, 370-D, respectively). The system 300 can receive user input via the right (left) arrow of control 320. In response to receiving the foregoing user input, the system 300 replace tiles 372-A′, 372-B′, 372-C′, 372-D′ depicting respective instances of the particular person' face in the panels 305-A, 305-B, 305-C, 305-D, respectively, with the respective succeeding (or preceding) tiles depicting respective instances of a third (or first) person' face from the tile sets 370-A, 370-B, 370-C, 370-D.

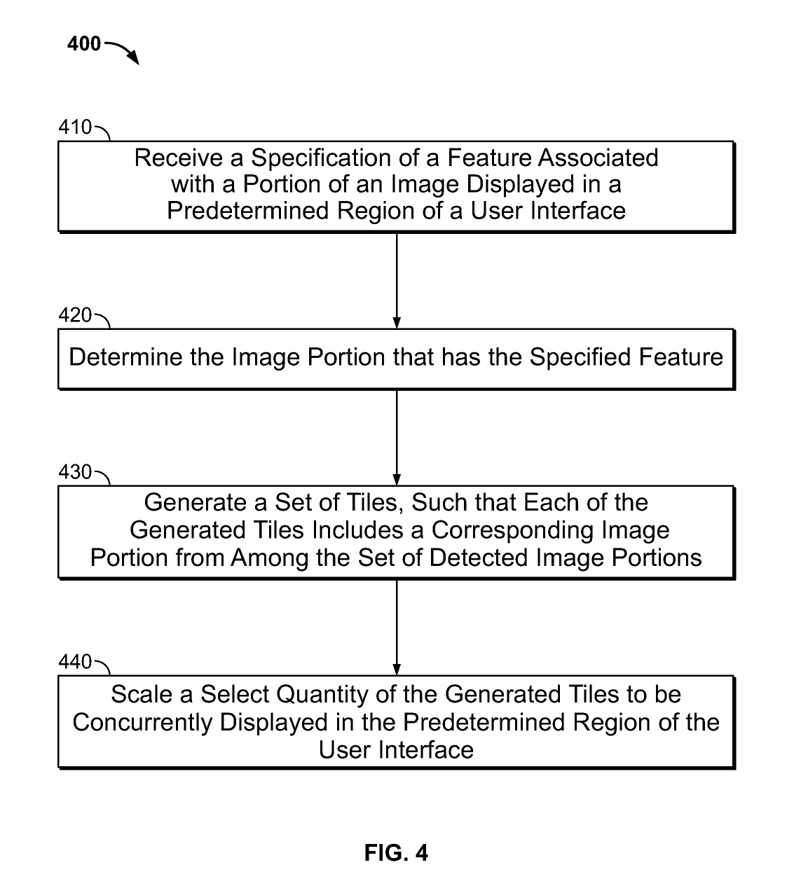

FIG. 4 shows an example of a process 400 for providing tiled zoom of multiple image portions that have a specified feature. In some implementations, the process 400 can be executed by one or more computers, for example in conjunction with system 100 to provide tiled zoom of multiple image portions that have a specified feature. For instance, the process 400 can be applied to an image displayed in a predetermined region of the user interface of system 100. In another instance, a subset of the process 400 can be applied to the image displayed in the predetermined region of the user interface of the system 100.

At 410, a user specification of a feature associated with a portion of the image is received. In some implementations, the user can specify that the image portion depicts an object. For example, the object can be a human face or an animal face (e.g. a pet's face) depicted in the image (e.g., as described in connection with FIGS. 2A-2C and 3A-3D.) In another example, the object can be one of a vehicle, a building, and the like, that is depicted in the image. In other implementations, the user can specify that the image portion is in focus. For example, the image portion can be considered to be in focus if it includes a focus location as recorded in metadata associated with the camera that acquired the image. As another example, the image portion can be considered in focus if edges depicted in the image portion meet a certain level of sharpness. In some other implementations, the user can specify that the image portion includes a predetermined image location, e.g., that the image portion is centered on a predetermined pixel. For example, the predetermined image location can be an image location to which the user zoomed during a previous viewing of the image. As another example, the predetermined image location can be any one of the centers of quadrants of the image.

At 420, one or more image portions that have the specified feature are determined. In implementations for which the specified feature is that a portion of the image depicts a face, one or more face detectors can be used to determine a portion of the image that bounds a face. Note that none, one or more than one face can be detected in the image, and the corresponding image portions depicting a face are determined as boxes bounding the detected one or more faces. In implementations for which the specified feature is that a portion of the image is in focus, the focus location(s) can be accessed in the metadata stored with the image, for example, and the image portion(s) can be determined as the box(es) having a predetermined size and being centered on the focus location(s). In another example, edge detectors can be used on determine the image portion(s) that is (are) in focus. In implementations for which the specified feature is that a portion of the image includes a predetermined image location, the latter can be accessed in the metadata stored with the image. For example, a pixel to which the image was zoomed last can be obtained (from persistent storage or from volatile memory.) The image portion can be determined in this case as a box centered on the obtained pixel and having a predetermined size, for instance. As another example, pixels corresponding to the centers of the four image quadrants can be calculated. Four image portions can be determined in this manner, each being centered on a center of the four image quadrants and having a predetermined size (e.g., 25%, 50%, . . . , smaller than the size of the image quadrant.)

At 430, tiles including the determined image portions that have the specified feature are generated. In some implementations, the tiles can be generated by cropping from the image corresponding image portions that are determined to have the specified feature. In other implementations, the tiles are generated by filling geometrical shapes of the determined image portions with image content corresponding to the image portions determined to have the specified feature. In some instances, however, in the implementations for which the specified feature is that a portion of the image depicts a face, detecting the one or more faces in the image at 420 and generating the tiles including the detected faces at 430 can be performed prior to displaying the image in the predetermined region of the user interface of system 100. In such instances, previously generated tiles can be accessed and retrieved without having to generate them on the fly as part of the process 400.

At 440, the generated tiles are scaled to be concurrently displayed in the predetermined region of the user interface. For example, in the implementation described above in connection with FIG. 1, the system 100 can switch from displaying the image in the predetermined region of the user interface to concurrently displaying the scaled tiles in the same predetermined region of the user interface, such that the scaled tiles replace the image for which the tiles ware generated.

In some implementations, the user can select a quantity of the tiles to be concurrently displayed in the predetermined region of the user interface, and such, the forgoing scaling is based on the select quantity. The select quantity (or all) of the scaled tiles can be displayed in the predetermined region of the user interface at a zoom level that is less than or equal to 100% and is larger than a zoom-level at which the image was displayed in the predetermined region. Concurrently displaying the scaled tiles in the predetermined region of the user interface can be performed in accordance with a display order that is different from a detection order. In the context of image portions that depict faces, multiple ways to establish the display order are described above in connection with FIG. 2B.

The method 400 can be implemented for processing one image displayed in a predetermined region of the user interface or multiple images displayed in respective images of the user interface. For instance, at least one other image can be concurrently displayed in respective other predetermined regions of the user interface. For each of the other images, a set of tiles is generated such that each of the tiles includes an image portion determined to have the specified feature, and each of the tiles from the set is scaled to be concurrently displayed in the other predetermined region associated with the other image. In addition, the other set of scaled tiles can be displayed in the other predetermined region associated with the other image concurrently with displaying all (or the select quantity) of the scaled tiles in the predetermined region of the graphical user interface. In some implementations, a display order (index) of the set of scaled tiles displayed in the other predetermined region of the user interface is the same as the display order used for displaying the scaled tiles in the predetermined region of the graphical user interface.

Optionally, user selection of a tile displayed in one of the predetermined regions of the user interface can be received. The selected tile includes an image portion for which the specified feature has a specified attribute. Upon receiving the user input and for each of the predetermined regions of the user interface, one or more tiles that include image portions for which the specified feature does not have the specified attribute are removed, and only a tile that includes an image portion for which the specified feature has the specified attribute is displayed in the associated predetermined region.

In context of the example implementation described above in connection with FIGS. 3B and 3D, the specified feature is that the image portion depicts a face, and the specified attribute is that the depicted face is associated with a particular person. Upon receiving user selection of a tile including an image portion that depicts a face associated with the particular person, for each set of scaled tiles displayed in the associated predetermined region of the user interface, system 300 removes one or more tiles including image portions that do not depict instances of the particular person's face, and displays in the associated predetermined region of the user interface only one tile including an image portion that depicts an instance of the particular person's face.

In context of the example implementation described above in connection with FIG. 1, the specified feature can be that the image portion is centered on the center of an image quadrant, and the specified attribute can be that the image quadrant is the upper-right quadrant. Upon receiving user selection of an upper-right quadrant, for each of the predetermined regions of the user interface that displays a set of four scaled tiles (corresponding to the four image quadrants), the system 100 can remove three tiles (including image portions corresponding to the centers of the upper-left, lower-left and lower-right quadrants), and can display in the associated predetermined region of the user interface only one tile (including an image portion that includes the center of the upper-right quadrant.)

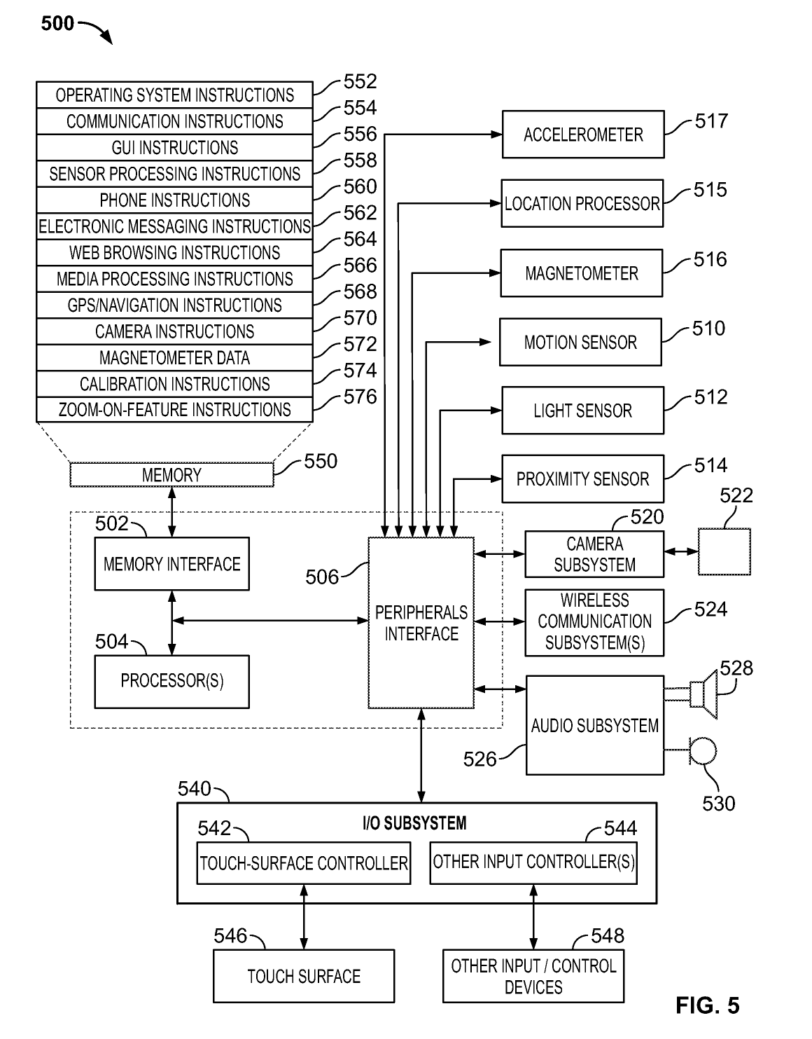

FIG. 5 is a block diagram of an example of a mobile device 500 operated according to the technologies described above in connection with FIGS. 1-4. A mobile device can include memory interface 502, one or more data processors, image processors and/or processors 504, and peripherals interface 506. Memory interface 502, one or more processors 504 and/or peripherals interface 506 can be separate components or can be integrated in one or more integrated circuits. Processors 504 can include one or more application processors (APs) and one or more baseband processors (BPs). The application processors and baseband processors can be integrated in one single process chip. The various components in mobile device 500, for example, can be coupled by one or more communication buses or signal lines.

Sensors, devices, and subsystems can be coupled to peripherals interface 506 to facilitate multiple functionalities. For example, motion sensor 510, light sensor 512, and proximity sensor 514 can be coupled to peripherals interface 506 to facilitate orientation, lighting, and proximity functions of the mobile device. Location processor 515 (e.g., GPS receiver) can be connected to peripherals interface 506 to provide geopositioning. Electronic magnetometer 516 (e.g., an integrated circuit chip) can also be connected to peripherals interface 506 to provide data that can be used to determine the direction of magnetic North. Thus, electronic magnetometer 516 can be used as an electronic compass. Accelerometer 517 can also be connected to peripherals interface 506 to provide data that can be used to determine change of speed and direction of movement of the mobile device.

Camera subsystem 520 and an optical sensor 522, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 524, which can include radio frequency receivers and transmitters and/or optical (e.g., infrared) receivers and transmitters. The specific design and implementation of the communication subsystem 524 can depend on the communication network(s) over which a mobile device is intended to operate. For example, a mobile device can include communication subsystems 524 designed to operate over a GSM network, a GPRS network, an EDGE network, a Wi-Fi or WiMax network, and a Bluetooth network. In particular, the wireless communication subsystems 524 can include hosting protocols such that the mobile device can be configured as a base station for other wireless devices.

Audio subsystem 526 can be coupled to a speaker 528 and a microphone 530 to facilitate voice-enabled functions, such as voice recognition, voice replication, digital recording, and telephony functions.

I/O subsystem 540 can include touch surface controller 542 and/or other input controller(s) 544. Touch-surface controller 542 can be coupled to a touch surface 546 (e.g., a touch screen or touch pad). Touch surface 546 and touch surface controller 542 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch surface 546.

Other input controller(s) 544 can be coupled to other input/control devices 548, such as one or more buttons, rocker switches, thumb-wheel, infrared port, USB port, and/or a pointer device such as a stylus. The one or more buttons (not shown) can include an up/down button for volume control of speaker 528 and/or microphone 530.

In some implementation, a pressing of the button for a first duration may disengage a lock of the touch surface 546; and a pressing of the button for a second duration that is longer than the first duration may turn power to mobile device 500 on or off. The user may be able to customize a functionality of one or more of the buttons. The touch surface 546 can, for example, also be used to implement virtual or soft buttons and/or a keyboard, such as a soft keyboard on a touch-sensitive display.

In some implementations, mobile device 500 can present recorded audio and/or video files, such as MP3, AAC, and MPEG files. In some implementations, mobile device 500 can include the functionality of an MP3 player, such as an iPod™. Mobile device 500 may, therefore, include a pin connector that is compatible with the iPod. Other input/output and control devices can also be used.

Memory interface 502 can be coupled to memory 550. Memory 550 can include high-speed random access memory and/or non-volatile memory, such as one or more magnetic disk storage devices, one or more optical storage devices, and/or flash memory (e.g., NAND, NOR). Memory 550 can store operating system 552, such as Darwin, RTXC, LINUX, UNIX, OS X, WINDOWS, or an embedded operating system such as VxWorks. Operating system 552 may include instructions for handling basic system services and for performing hardware dependent tasks. In some implementations, operating system 552 can include a kernel (e.g., UNIX kernel).

Memory 550 may also store communication instructions 554 to facilitate communicating with one or more additional devices, one or more computers and/or one or more servers. Memory 550 may include graphical user interface instructions 556 to facilitate graphic user interface processing; sensor processing instructions 558 to facilitate sensor-related processing and functions; phone instructions 560 to facilitate phone-related processes and functions; electronic messaging instructions 562 to facilitate electronic-messaging related processes and functions; web browsing instructions 564 to facilitate web browsing-related processes and functions; media processing instructions 566 to facilitate media processing-related processes and functions; GPS/Navigation instructions 568 to facilitate Global Navigation Satellite System (GNSS) (e.g., GPS) and navigation-related processes and instructions; camera instructions 570 to facilitate camera-related processes and functions; magnetometer data 572 and calibration instructions 574 to facilitate magnetometer calibration. The memory 550 may also store other software instructions (not shown), such as security instructions, web video instructions to facilitate web video-related processes and functions, and/or web shopping instructions to facilitate web shopping-related processes and functions. In some implementations, the media processing instructions 566 are divided into audio processing instructions and video processing instructions to facilitate audio processing-related processes and functions and video processing-related processes and functions, respectively. An activation record and International Mobile Equipment Identity (IMEI) or similar hardware identifier can also be stored in memory 550. Memory 550 can include tiled zoom instructions 576 that can include tiled zoom functions, and other related functions described with respect to FIGS. 1-4.

Each of the above identified instructions and applications can correspond to a set of instructions for performing one or more functions described above. These instructions need not be implemented as separate software programs, procedures, or modules. Memory 550 can include additional instructions or fewer instructions. Furthermore, various functions of the mobile device may be implemented in hardware and/or in software, including in one or more signal processing and/or application specific integrated circuits.

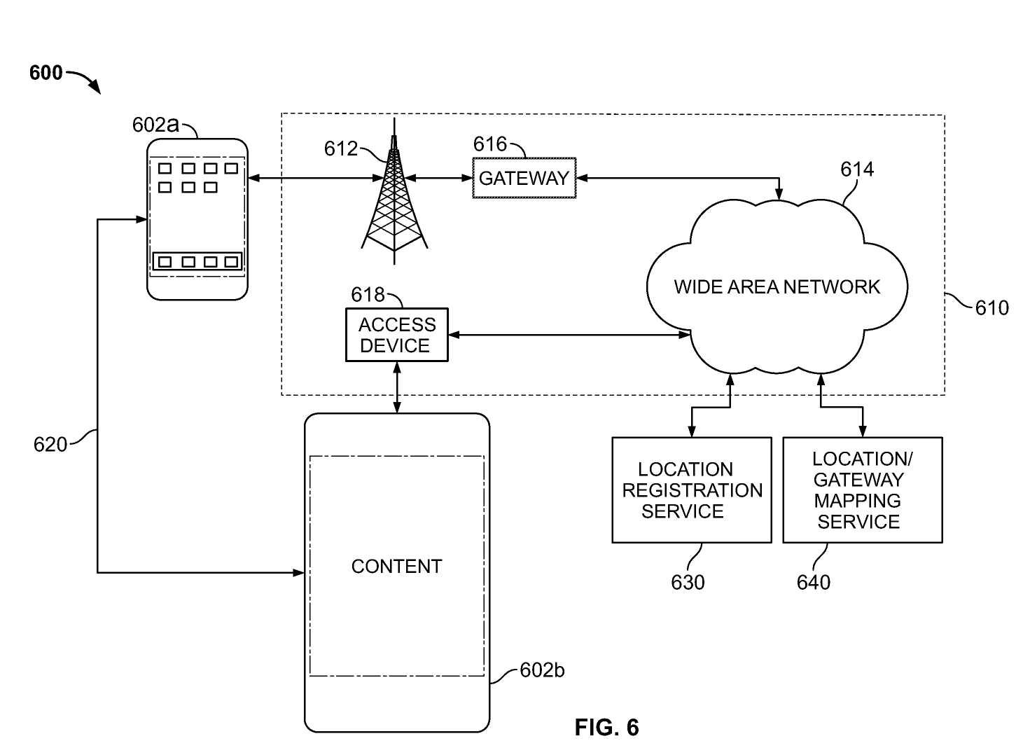

FIG. 6 is a block diagram of an example of a network operating environment 600 for mobile devices operated according to the technologies described above in connection with FIGS. 1-4. Mobile devices 602a and 602b can, for example, communicate over one or more wired and/or wireless networks 610 in data communication. For example, a wireless network 612, e.g., a cellular network, can communicate with a wide area network (WAN) 614, such as the Internet, by use of a gateway 616. Likewise, an access device 618, such as an 802.11g wireless access device, can provide communication access to the wide area network 614.

In some implementations, both voice and data communications can be established over wireless network 612 and the access device 618. For example, mobile device 602a can place and receive phone calls (e.g., using voice over Internet Protocol (VoIP) protocols), send and receive e-mail messages (e.g., using Post Office Protocol 3 (POP3)), and retrieve electronic documents and/or streams, such as web pages, photographs, and videos, over wireless network 612, gateway 616, and wide area network 614 (e.g., using Transmission Control Protocol/Internet Protocol (TCP/IP) or User Datagram Protocol (UDP)). Likewise, in some implementations, the mobile device 602b can place and receive phone calls, send and receive e-mail messages, and retrieve electronic documents over the access device 618 and the wide area network 614. In some implementations, mobile device 602a or 602b can be physically connected to the access device 618 using one or more cables and the access device 618 can be a personal computer. In this configuration, mobile device 602a or 602b can be referred to as a “tethered” device.

Mobile devices 602a and 602b can also establish communications by other means. For example, wireless device 602a can communicate with other wireless devices, e.g., other mobile devices 602a or 602b, cell phones, etc., over the wireless network 612. Likewise, mobile devices 602a and 602b can establish peer-to-peer communications 620, e.g., a personal area network, by use of one or more communication subsystems, such as the Bluetooth™ communication devices. Other communication protocols and topologies can also be implemented.

The mobile device 602a or 602b can, for example, communicate with one or more services 630 and 640 over the one or more wired and/or wireless networks. For example, one or more location registration services 630 can be used to associate application programs with geographic regions. The application programs that have been associated with one or more geographic regions can be provided for download to mobile devices 602a and 602b.

Location gateway mapping service 640 can determine one or more identifiers of wireless access gateways associated with a particular geographic region, and provide the one or more identifiers to mobile devices 602a and 602b for registration in association with a baseband subsystem.

Mobile device 602a or 602b can also access other data and content over the one or more wired and/or wireless networks. For example, content publishers, such as news sites, Really Simple Syndication (RSS) feeds, web sites, blogs, social networking sites, developer networks, etc., can be accessed by mobile device 602a or 602b. Such access can be provided by invocation of a web browsing function or application (e.g., a browser) in response to a user touching, for example, a Web object.

Implementations of the subject matter and the functional operations described in this specification can be configured in digital electronic circuitry, in tangibly-embodied computer software or firmware, in computer hardware, including the structures disclosed in this specification and their structural equivalents, or in combinations of one or more of them. Implementations of the subject matter described in this specification can be configured as one or more computer programs, i.e., one or more modules of computer program instructions encoded on a tangible nonvolatile program carrier for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be configured on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be configured in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular implementations of particular inventions. Certain features that are described in this specification in the context of separate implementations can also be configured in combination in a single implementation. Conversely, various features that are described in the context of a single implementation can also be configured in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method performed by one or more processes executing on a computer system, the method comprising:
concurrently displaying a plurality of digital images in respective panels of a graphical user interface;
receiving user input requesting to zoom onto faces depicted in the digital images, where the faces include either human faces or animal faces;
in response to said receiving the user input and for each of the plurality of digital images, obtaining a set of tiles such that each of the tiles bounds a face depicted in the image; and
switching from said concurrently displaying the plurality of digital images to concurrently displaying the obtained sets of tiles in the respective panels, such that each of the sets of tiles replaces a digital image for which the set of tiles was obtained.

2. The method of claim 1 where
said concurrently displaying the plurality of digital images in the respective panels corresponds to a first zoom-level smaller than 100%, and
said concurrently displaying the obtained sets of tiles in the respective panels corresponds to a second zoom-level larger than the first zoom-level and no larger than 100%.

3. The method of claim 1 where, for each of the plurality of digital images, said obtaining the set of tiles comprises
detecting a set of faces depicted in the digital image upon receiving the zoom request, and
generating the set of tiles such that each of the tiles bounds a detected face.

4. The method of claim 1 where, for each of the plurality of digital images, said obtaining the set of tiles comprises accessing and retrieving the set of tiles that was generated prior to receiving the zoom request, where the set of tiles was generated at least in part by
detecting a set of faces depicted in the digital image, and
generating the set of tiles such that each of the tiles bounds a detected face.

5. The method of claim 1 where said concurrently displaying the obtained sets of tiles in the respective panels comprises displaying each of the sets based on a display order within a set of tiles obtained for a particular image.

6. The method of claim 5 where the particular image is an image from among the plurality of digital images that has a largest quantity of depicted faces.

7. The method of claim 5 where the particular image is an image from among the plurality of digital images that has a largest quantity of depicted faces that are members of a specified group.

8. The method of claim 5 where the particular image is user specified.

9. The method of claim 5 where the display order within the set of tiles is based on a detection order of the faces depicted in the particular image.

10. The method of claim 5 where the display order within the set of tiles is based on identity of unique individuals associated with the faces depicted in the particular image.

11. The method of claim 1, further comprising:
receiving a user selection of a tile from among the obtained set of tiles that is displayed in one of the panels;
removing one or more unselected tiles from among the obtained set of tiles displayed in the panel associated with the selected tile; and
displaying the selected tile in the panel at a third zoom-level larger than the second zoom-level and less than or equal to 100%, in response to said removing the unselected tiles.

12. The method of claim 1, further comprising:
receiving selection of a tile from among the obtained set of tiles displayed in one of the panels, the selected tile associated with a depicted face; and
for each of the respective panels corresponding to the plurality of digital images,
removing one or more tiles that are not associated with instances of the depicted face with which the selected tile is associated, and
displaying in the panel a tile associated with an instance of the depicted face with which the selected tile is associated, such that said displaying the tile corresponds to a third zoom-level larger than the second zoom-level and less than or equal to 100%, in response to said removing the tiles that are not associated with the instances of the depicted face with which the selected tile is associated.

13. A method performed by one or more processes executing on a computer system, the method comprising:
displaying a digital image in a predetermined region of a user interface;
receiving a user specification of a feature associated with a portion of the digital image;
detecting a set of two or more image portions, such that each of the detected image portions includes the specified feature;
generating a set of tiles, such that each of the generated tiles includes a corresponding image portion from among the set of detected image portions; and
scaling a select quantity of the generated tiles to be concurrently displayed in the predetermined region of the user interface.

14. The method of claim 13 where the user specification specifies that the image portion depicts an object.

15. The method of claim 14 where the object comprises a human face.

16. The method of claim 14 where the object comprises an animal face.

17. The method of claim 14 where the object comprises a vehicle or a building.

18. The method of claim 13 where the user specification specifies that the image portion is in focus.

19. The method of claim 13 where the user specification specifies that the image portion includes a predetermined image location.

20. The method of claim 19 where the predetermined image location comprises an image location to which the user zoomed during a previous viewing of the digital image.

21. The method of claim 19 where the predetermined image location comprises any one of the centers of quadrants of the digital image.

22. The method of claim 13, further comprising receiving a user selection of the quantity of the scaled tiles to be concurrently displayed in the predetermined region of the user interface.

23. The method of claim 13, further comprising concurrently displaying the select quantity of scaled tiles in the predetermined region of the user interface at a zoom level that is less than or equal to 100% and larger than a zoom-level at which the digital image was displayed in the predetermined region.

24. The method of claim 23, where said concurrently displaying the select quantity of scaled tiles in the predetermined region of the user interface is performed in accordance with a display order that is different from a detection order.

25. The method of claim 23, further comprising:
concurrently displaying at least one other digital image in respective other predetermined regions of the user interface;
for each of the other digital images,
generating a set of tiles such that each tile includes an image portion detected to include the specified feature, and
scaling each of the set of tiles to be concurrently displayed in the other predetermined region associated with the other digital image; and
concurrently displaying at least one set of scaled tiles corresponding to the other digital images in the associated other predetermined regions at a respective zoom level that is less than or equal to 100% and larger than respective zoom-levels at which the other digital images were displayed in the associated other predetermined region.

26. The method of claim 25, where said concurrently displaying the sets of scaled tiles in the associated other predetermined regions of the user interface is performed in accordance with the same display order used for said concurrently displaying the select quantity of scaled tiles in the predetermined region of the user interface.

27. The method of claim 25, further comprising:
receiving user selection of a tile from among the select quantity of scaled tiles displayed in the predetermined region of the user interface, the selected tile including an image portion including the specified feature, such that the specified feature has a specified attribute; and
for each of the predetermined region and the other predetermined regions corresponding to the digital image and to the other digital images, respectively,
removing one or more tiles that include image portions for which the specified feature does not have the specified attribute, and
displaying in the associated predetermined region a tile that includes an image portion for which the specified feature has the specified attribute.

28. The method of claim 27, where the specified feature specifies that the image portion depicts a human face or an animal face and the specified attribute specifies that the depicted face is associated with a specified person or a specified pet.

29. A system comprising:
one or more computers and one or more storage devices storing instructions that are operable, when executed by the one or more computers, to cause the one or more computers to perform operations comprising:
displaying two or more digital images in respective panels at respective initial zoom-levels; and
in response to receiving user input requesting to zoom onto human or animal faces depicted in the digital images, displaying two or more sets of depicted faces in the respective panels corresponding to the two or more digital images, the sets of depicted faces being displayed at respective zoom-levels larger than the initial zoom-levels at which the corresponding digital images were displayed.

30. The system of claim 29 where the operations further comprise detecting the respective sets of faces in the two or more displayed digital images upon receiving the user request.

31. The system of claim 29 where the operations further comprise accessing and retrieving the respective sets of faces in the two or more displayed digital images that were detected prior to receiving the user request.

32. The system of claim 29 where the operations further comprise:
receiving selection of a face from among the set of depicted faces displayed in a panel from among the respective panels corresponding to the two or more digital images; and
removing unselected faces from among the set of depicted faces displayed in the panel.

33. The system of claim 29 where the operations further comprise:
receiving selection of a face from among the set of depicted faces displayed in a panel from among the respective panels corresponding to the two or more digital images; and
removing instances of unselected faces from among the respective sets of depicted faces displayed in the respective panels corresponding to the two or more digital images.

34. The system of claim 29 where said displaying the respective sets of the depicted faces comprises sorting the respective sets by relative positions within the corresponding two or more digital images.

35. The system of claim 29 where said displaying the respective sets of the depicted faces comprises sorting the respective sets by an identity of the depicted faces.
